(19) United States
(12) Patent Application Publication
(10) Pub. No.: US 2005/0189366 A1
(43) Pub. Date: Sep. 1, 2005

(54) Bag packaging dispenser and method

(76) Inventor: Jerry Sommers, Pickerington, OH (US)

Correspondence Address: Kenneth W. Fafrak;Renner, Otto, Boisselle & Sklar, LLP, Nineteenth Floor, 1621 Euclid Avenue, Cleveland, OH, 44115, US

(21) Appl. No.: 10/771,892

(22) Filed: Feb. 4, 2004

(51) Int. Cl. B65H 1/00; G07F 11/00; B65G 59/00

(52) U.S. Cl. 221/34; 221/1

(57) ABSTRACT

A container for storing, transporting and dispensing multiple bags is disclosed. A divider within the container forms multiple compartments for storing each type of bag. A dispensing outlet is included for each compartment within the container. The dispensing outlets are formed on a top wall of the container and/or on a front and back wall of the container. The bags are removed from the container through their respective dispensing outlet.

### FIELD OF THE INVENTION

The present invention relates generally to bag packaging and, more particularly, to a dispenser and method for storing, transporting and dispensing multiple types of bags and the like. The invention also relates to an approach for storing, transporting and dispensing multiple types of bags and the like from the same container.

### BACKGROUND OF THE INVENTION

Bags come in many different sizes and have many different purposes. For example, plastic bags are used for the storage of food, including short term storage, e.g, sandwich bags, and long term storage, e.g., freezer bags. Sandwich bags and/or multipurpose storage bags, for example, are used to pack sandwiches and snacks, e.g., chips, pretzels, vegetables, etc. Sandwich bags generally come in about five inch by five inch size and are made from a thin ply plastic material. Freezer bags, on the other hand, generally are used for long term storage of food items in a freezer. Freezer bags typically range in size from about one quart to several gallons and are manufactured from a thick plastic material.

Plastic bags also are used for the collection and disposal of trash. Trash bags, as they are referred to, come in various sizes and shapes depending on their intended use. For example, kitchen trash bags typically range in size from about two gallons to fifteen gallons and are made from a thin plastic material. Outdoor trash bags, on the other hand, can be much larger, ranging in size from about twenty gallons to eighty gallons. Furthermore, outdoor trash bags are made from a thicker or multi-ply plastic material to provide adequate strength and to prevent breakage of the bag. As will be appreciated, plastic bags can have numerous other uses.

Plastic bags also include various closing and/or sealing mechanisms to protect the enclosed item (e.g., food) from contaminants. For example, some bags include a simple fold over flap to close the bag. Generally speaking, an inner flap of the bag is folded around an outer edge of the enclosed item and an outer flap of the bag is folded over the inner flap, thus closing the bag. These bags protect the contents of the bag from direct contact with potential contaminants, but the fold over flap inherently does not provide an air tight seal. Thus, airborne contaminants may make their way past the flap seal. To address this problem, zipper seals have been implemented in plastic bags. The zipper seal provides an air-tight seal, thus not only preventing contamination through direct contact, but also preventing contamination through airborne matter.

Plastic bags may be stored, transported and dispensed from conventional cartons. The bags may be stored in such cartons in a stack or in a roll. Other types of material may be stored in such cartons, such as foil, wax paper, wrapping paper, plastic wrap, and other materials that usually are stored in a roll or in a stack. A typical carton has a bottom wall, opposing front and back walls, a pair of opposing side walls, and a top wall.

One technique for dispensing plastic bags from a carton is to stack the bags in the carton, one on top of another, with the bags oriented in the same direction. A single slot or cut out is provided in the top wall of the carton for dispensing the plastic bags. As one bag is removed from the slot, the next bag is positioned at the opening of the slot and becomes ready for removal. Another technique for arranging the plastic bags in the carton is to stack them one on top of another with alternate individual or sets of bags oriented in an opposite direction. Again, the bags are stored, transported and dispensed from a conventional carton having four walls and two sides, and a slot is provided for dispensing the bags. Still another technique is to store the bags in a roll, sequential bags being perforated to facilitate separating one bag from the next one.

A drawback of conventional packaging of plastic bags or the other materials mentioned above is that each size and each type of plastic bag requires a separate container to store, transport and dispense the respective bag. Thus, an individual who uses several types of trash bags, e.g., small trash bags, medium trash bags and large trash bags, as well as several types of food bags, e.g., freezer bags and sandwich bags, will have to store numerous containers for each type of bag. In many instances, finding enough storage space can become a problem.

Accordingly, there is a need in the art for a packaging device that reduces the number of containers needed to store, transport and dispense plastic bags and the like.

There also is a need in the art to facilitate storage of bags and access to bags that are stored.

There also is a need to improve the versatility of packaging for bags and other materials that can be stored in sheet-like or roll format.

### SUMMARY OF THE INVENTION

In light of the foregoing, one aspect of the invention relates to a packaging device that includes a container, a divider cooperative with at least a portion of the container forming a plurality of compartments within the container, and a plurality of dispensing outlets in the container to dispense respective objects from the respective compartments.

Another aspect of the invention relates to a method of packaging sheet-like objects, including the steps of providing a container to house the objects, creating a plurality of dispensing outlets, placing a divider in the container, wherein the divider forms a plurality of compartments within the container, and each of the plurality of compartments corresponds to one of the plurality of dispensing outlets, placing a plurality of sheet-like objects in each of the plurality of compartments, and closing the container.

Another aspect of the invention relates to a method of dispensing from a container sheet-like material having different characteristics, wherein material having one characteristic is in one compartment of the container and material having a different characteristic is in a different compartment of the container, including the step of withdrawing material having one of such characteristics from the respective compartment of the container via a respective dispensing opening associated with such compartment.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 illustrates a prior art container for plastic bags.

FIG. 2 illustrates a container for storing, transporting and dispensing plastic bags in accordance with an embodiment of the invention, the container outlets being in one wall of the container.

FIG. 3 illustrates a divider within the container of FIG. 2 in accordance with an embodiment of the invention.

FIG. 4A illustrates the divider in accordance with an embodiment of the invention.

FIG. 4B is an end view of the divider of FIG. 4A.

FIG. 4C is a side view of the divider of FIG. 4A.

FIG. 4D is a top view of the divider of FIG. 4A.

FIG. 5 is a plan view of the container of FIG. 2 in flattened unassembled condition.

FIG. 6 illustrates a container for storing, transporting and dispensing plastic bags in accordance with another embodiment of the invention, the container outlets being in the front and back walls and a portion of the top wall of the container.

FIG. 7 is a plan view of the container of FIG. 6 in flattened unassembled condition.

FIG. 8 illustrates a container for storing, transporting and dispensing plastic bags in accordance with another embodiment of the invention, the container outlets being in the front and back walls.

FIG. 9 is a plan view of the container of FIG. 8 in flattened unassembled condition.

### DESCRIPTION

The following description refers to the attached drawings, wherein like reference numerals refer to like elements throughout. Although described with respect to plastic bags, it will be appreciated that the invention may be used with and for the other materials mentioned above and other similar materials able to be packaged, stored and dispensed as described herein.

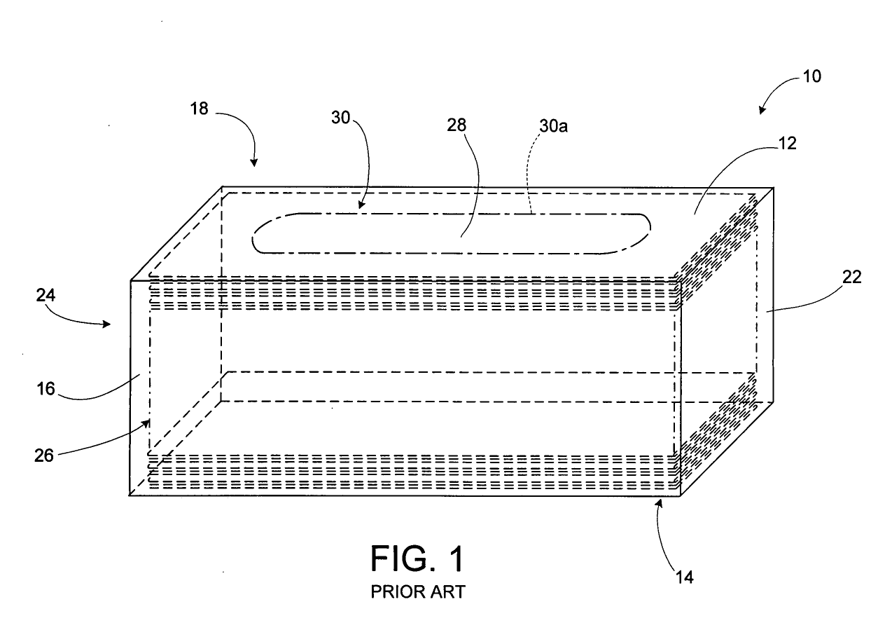

Referring to FIG. 1, a prior art container or package 10 for plastic bags is illustrated. The container 10 generally is rectangular in shape and includes a top wall 12, a bottom wall 14, a front wall 16 and a back wall 18. A right sidewall 22 and a left sidewall 24 complete the outer surface of the container 10. Plastic bags 26, for example, are placed inside the container 10 in a roll or stack-like manner, and the combination of the plastic bags 26 and the container 10 is sold as a single unit. A dispensing outlet 28 provides an opening into the container 10 for removing one or more plastic bags from the container 10.

The container 10 typically is manufactured from a thin board-like material such as, for example, cardboard. Alternatively, the container can be manufactured from plastic, metal, paper, etc. The container has dimensions slightly larger than the stack or roll of plastic bags 26 within the container 10. The bags are dispensed by opening the dispensing outlet 28 and withdrawing a bag from the dispensing outlet. Typically, the dispensing outlet 28 is formed in the top wall 12 of the container 10 by perforating a portion 30 of the top wall 12. The bags 26 and the container 10 are sold with the perforated portion 30 in place. Exemplary perforations are shown at 30a in the drawing. The first time a bag is removed from the container 10, the dispensing outlet 28 is opened by tearing and, if desired, removing the perforated portion 30 of the top wall 12.

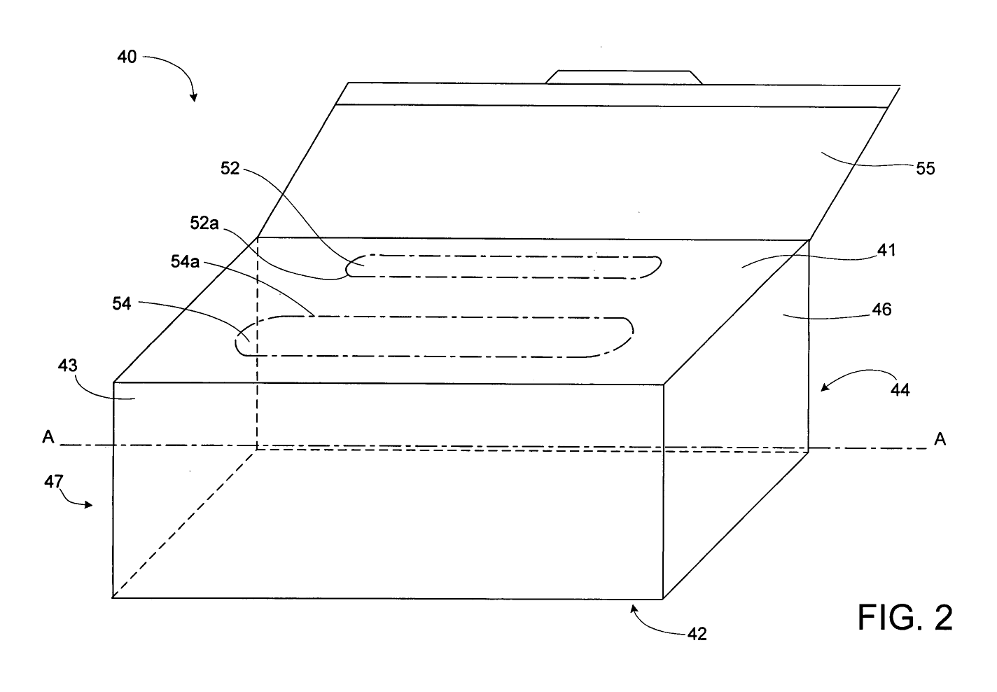

Referring now to FIG. 2, a container 40 in accordance with an embodiment of the present invention is illustrated. The container or package 40 has several compartments that are sufficiently separated to store respective different sized objects, such as bags, therein and from which the bags may be separately dispensed.

The container 40 generally is rectangular in shape and includes a top wall 41, a bottom wall 42, a front wall 43, a back wall 44, a right sidewall 46 and a left sidewall 47. The actual shape of the container may be other than rectangular, e.g., pentagonal, hexagonal, oval, or some other shape or cross section. The container 40 includes a first dispensing outlet 52 and a second dispensing outlet 54, both in the top wall 41 of the container 40. The first dispensing outlet 52 and the second dispensing outlet 54 are formed by perforating a portion of the top wall 41 in a desired shape, for example, and the outlets are closed until perforations are torn or broken to open a respective outlet. Exemplary perforations are shown at 52a, 54a. An optional lid or cover 55 allows the outlets 52, 54 to be closed when the container is stored and/or not in use. Exemplary perforations are shown at 52a, 54a.

As illustrated, the container 40 is relatively elongate in the direction of an axis A, and the cross-sectional shape of the container is square. Such shape may be other than square or rectangular, as is described elsewhere herein. The dispensing outlets are somewhat elongate in a direction generally parallel to the axis A and the bags or other material in the container that are dispensed from the dispensing outlets are arranged relative to the dispensing outlets and/or axis to facilitate convenient dispensing thereof through the dispensing outlets without damage to the bags.

The extent of elongation of the axis A, i.e., the dimension of the container in the direction of the axis A, relative to other dimensions of the container 40 may vary according to the sizes of the bags to be stored in the container and the number of bags to be stored. If a large number of bags were to be stored in the container 40 it is possible that the actual length of elongation would be smaller than a cross-sectional dimension of the container.

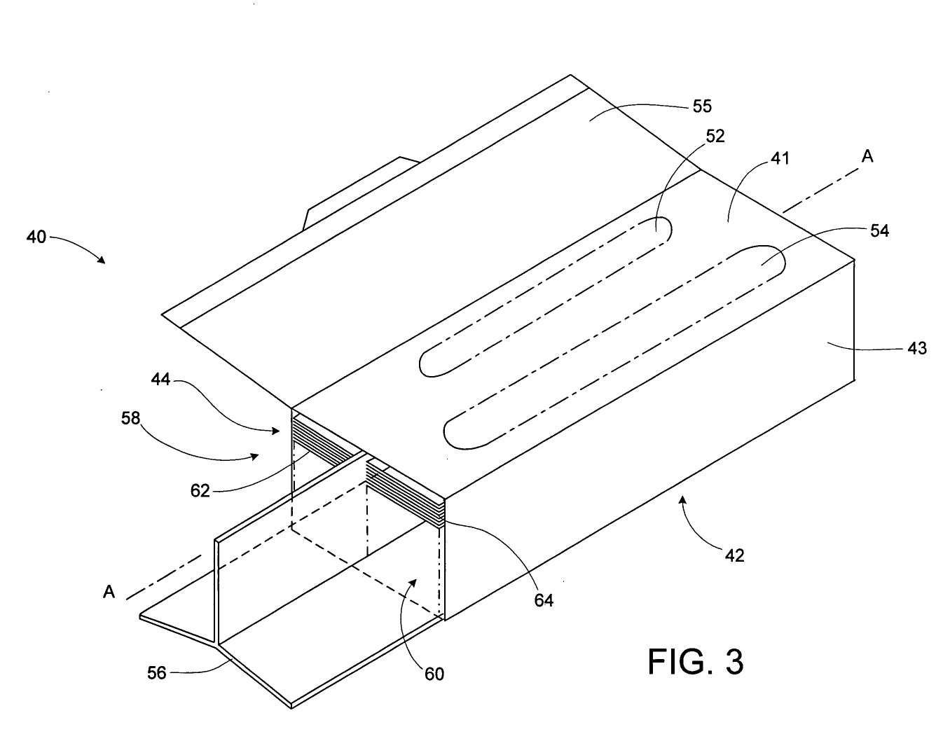

With further reference to FIG. 3, the container 40 also includes a divider 56, which is in the container 40. The divider 56 will be described in more detail below. The divider divides the container interior space to form two compartments within the container 40, a first compartment 58 and a second compartment 60. The two compartments are separated from one another by the divider 56. The first dispensing outlet 52 corresponds to the first compartment 58, e.g., the first compartment 58 can be accessed through the first dispensing outlet 52, and the second dispensing outlet 54 corresponds to the second compartment 60, e.g., the second compartment 60 can be accessed through the second dispensing outlet 54. A first stack (or roll) of bags 62 is stored in the first compartment 58, and a second stack (or roll) of bags 64 is stored in the second compartment 60. Thus, the container 40 can store, transport and dispense two different sizes of bags or two different types of bags. For example, the first compartment 58 may house quart size food storage bags while the second compartment 60 may house gallon size food storage bags. Alternatively, the first compartment 58 may house standard weight storage bags, sandwich bags or the like while the second compartment 60 may house heavy weight freezer bags or other heavy weight bags, for example. The container is constructed to be slightly larger than the dimensions of the bags it will house, for example.

It should be appreciated that the invention may be applied to all type of bags and other materials as mentioned above, and the reference to plastic bags is merely exemplary and is not intended to be limiting in any way.

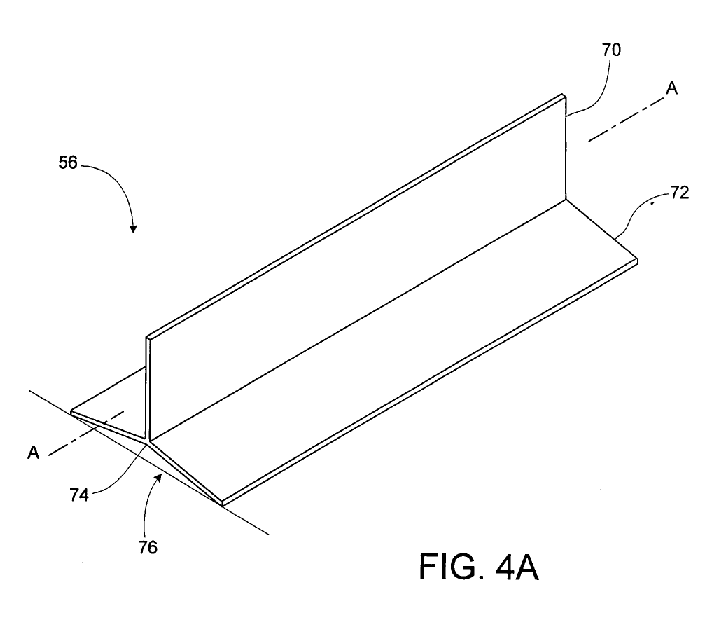

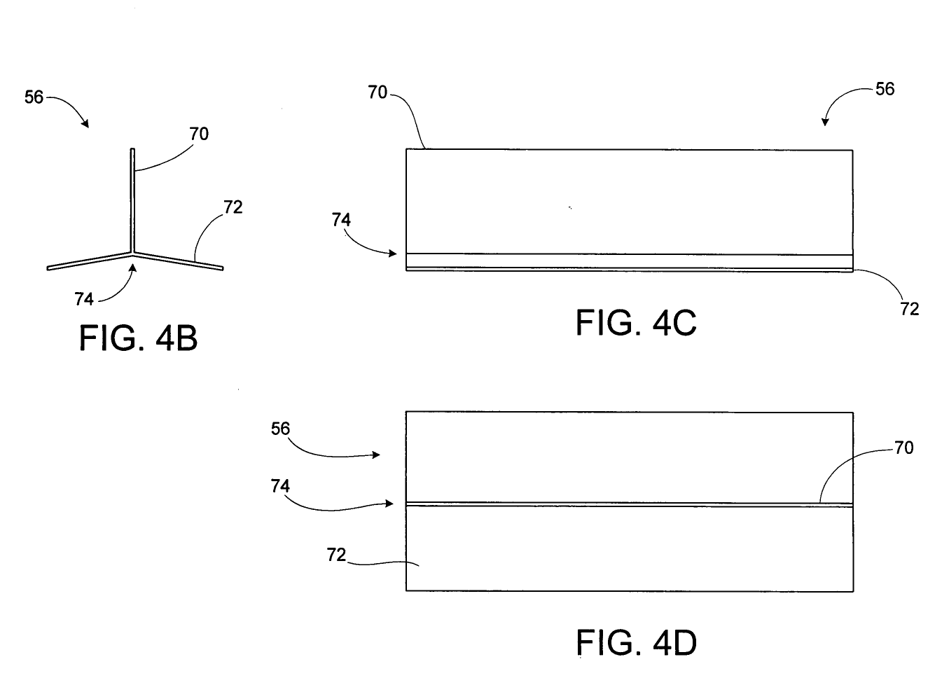

Referring now to FIG. 4A through FIG. 4D, the divider 56 will be described in more detail. The divider 56, which, for example, can be formed from plastic and/or cardboard materials or other suitable material, creates the compartments 58, 60 within the container 40. In one embodiment the divider 56 includes a vertical wall 70 attached to a base 72. The vertical wall 70 is fixedly attached to the base 72 using an adhesive, for example. Alternatively, the vertical wall 70 and the base 72 may be an integral unit, e.g., a one-piece assembly such as an extruded or molded plastic. The vertical wall 70 may be other than rectangular and, if desired, may be other than flat planar, e.g., curved, undulating, etc. The vertical wall 70 is formed from a generally planar member having a rectangular shape, for example. The base 72 is formed to raise or elevate a center portion 74 of the base 72 slightly above a floor level 76. The base 72 can be formed, for example, from two planar members having a generally rectangular shape, and attaching the two members together at a slight angle relative to each other, e.g., 5 degrees, to form the raised center portion 74. Alternatively, the base 72 can be created from a single member, wherein the member is formed to raise the center portion 74 of the base 72. In another embodiment, the base 72 is formed from a single planar member and does not have a raised center portion. Also, as was mentioned above, the base 72 and wall 70 may be an integral unit, e.g., a one piece extrusion or a molded part, etc. The divider 56 is constructed to fit within the container, e.g., the length, width and height of the divider is slightly less than the inner dimensions of the container. For a 6×2×2 inch container, the divider may be 5.9 inches long, 1.9 inches tall and have a base of about 1.9 inches in width, for example. Depending on the product placed in the container, the divider may be permanently affixed in the container, e.g., glued in place, or it may be slid into place and allowed to “float” within the container. Additionally, the divider may take on different shapes to accommodate the different products.

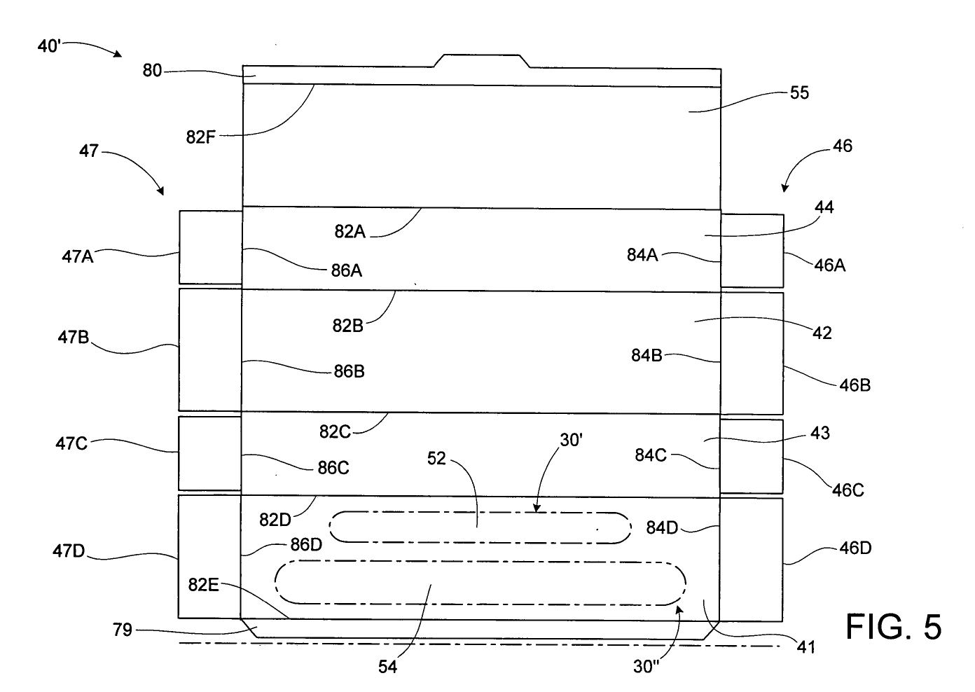

Moving now to FIG. 5, a plan view 40′ of the container 40 is illustrated. The plan view 40′ illustrates how the container 40 can be formed from a sheet of material, such as, for example, a thin sheet of cardboard. As can be seen in FIG. 5, the plan view 40′ includes the top wall 41, the bottom wall 42, the front wall 43, the back wall 44, the lid 55, a first flap 79, and a second flap 80. Form guides 82A-82F indicate where to fold or “form” the container material to create the rectangular container shape. For example, a cardboard container is formed by cutting the cardboard as shown in the plan view 40′ and folding along the predefined form guides at angles of about 90 degrees relative to an adjacent wall. After each form guide 82A-82F has been folded, an adhesive (not shown) is placed and/or included on the first flap 79, and the first flap is attached to the back wall 44 of the container 40. An adhesive also is placed and/or included on the second flap 80, and the lid 55 is folded over the top wall 41 of the container and the second flap 80 is attached to the front wall 43.

The sidewalls 46, 47 of the container 40 are formed from several sidewall flaps. For example, the right sidewall 46 includes four flaps 46A-46D and the left sidewall 47 includes four flaps 47A-47D. It will be appreciated that more or fewer flaps may be implemented to form the sidewalls 46, 47 of the container 40 without departing from the scope of the invention. Right sidewall form guides 84A-84D indicate where the right sidewall flaps 46A-46D are folded and/or formed to create the right sidewall 46 of the container 40. For example, a first right flap 46A is folded along a first right form guide 84A at an angle of about ninety degrees relative to the back wall 44 and a third right flap 46C is folded along a third right form guide 84C at an angle of about ninety degrees relative to the front wall 43. A second right flap 46B is folded along a second right form guide 84B at an angle of about ninety degrees relative to the bottom wall 42 and a fourth right flap 46D is folded along a fourth right form guide 84D at an angle of about ninety degrees relative to the top wall 41. An adhesive (not shown) is placed and/or included on the right sidewall flaps to secure the right sidewall, for example. The left sidewall 47 of the container 40 is formed in a similar manner. A first left flap 47A is folded along a first left form guide 86A at an angle of about ninety degrees relative to the back wall 44 and a third left flap 47C is folded along a third left form guide 86C at an angle of about ninety degrees relative to the front wall 43. A second left flap 47B is folded along a second left form guide 86B at an angle of about ninety degrees relative to the bottom wall 42 and a fourth left flap 47D is folded along a fourth left form guide 86D at an angle of about ninety degrees relative to the top wall 41. The left sidewall flaps are secured using an adhesive, for example.

The plan view 40′ of the container 40 also shows the first dispensing outlet 52 and the second dispensing outlet 54. The dispensing outlets 52, 54 are formed in the top wall 41 by perforating a portion 30′, 30″ of the top wall 41 in a desired shape, for example.

The above description of assembling the container 40 is exemplary. It will be appreciated that other approaches may be used to assemble the container 40. Also, the container may be of a shape other than rectangular, e.g., pentagonal, hexagonal, oval, etc., and the manner of assembling the container may vary with the shape or cross-section of the container 40. Other methods of making and/or assembling the container may be employed.

The shapes and sizes of the dispensing outlets as well as the location of the outlets may be configured, as desired, to accommodate the size of bags or other material that is to be dispensed therefrom. For example, the perforations and/or the dispensing outlets may be in various places, such as on one or more sides, top or bottom of the container. Also, although the dispensing outlets 52, 54 are shown as perforations in a wall of the container, it will be appreciated that along an edge of a dispensing outlet may be a cutting devices, such as a serrated material, to facilitate cutting off sheet material that is withdrawn from the container through a dispensing outlet. Also, if desired, the outlets may be formed as other than perforations to provide a slot-like opening as illustrated. For example, as is conventional in some containers for sheet material such as plastic wrap, a cover portion of a container may open and allow access to the sheet material in the container allowing the sheet material to be pulled out through a gap between a part of the cover and another portion of the container. Serrated material also may be used in such case to facilitate cutting a section of sheet material from the balance of the sheet material that already is stored in the container.

In using the container 40, bags of different respective sizes are loaded into the respective compartments 58, 60 (or, if desired, the same size bags may be loaded into both compartments 58, 60). The container 40 with the bags in the compartments may be stored, shipped, or used to dispense the respective bags. For use, one or both dispensing outlets 52, 54 may be opened and bags may be withdrawn from the respective dispensing outlets and, thus, made available for subsequent use.

The divider 56 separates the bags so that the bags in one compartment do not become mixed with the bags of the other compartment. Moreover, the shape of the divider 56 may be such as to facilitate positioning bags in respective compartments 58, 60 and/or dispensing the bags from the compartments through the dispensing outlets 52, 54. For example, the raised or convex shape of the center portion 74 of the divider base 72 facilitates positioning of the bags in the compartments and the withdrawing of the bags by holding the bags at an angle other than perpendicular to the direction of bag withdrawal from a compartment. Such angular relation facilitates grasping a bag in the event the edge of the next bag slips below the container surface at which the dispensing outlet is located.

Although the divider is shown as a separate part from the container, the divider may be an integral part of the container, e.g., being formed by respective folded cardboard parts of the container or otherwise formed.

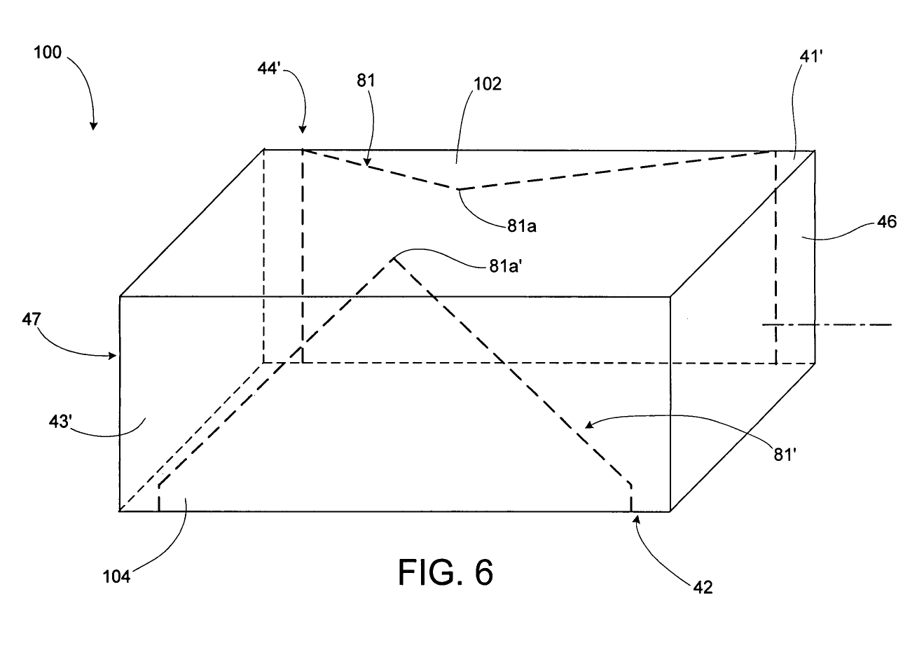

Referring now to FIG. 6, another embodiment of container 100 is illustrated. The container 100 is similar to the container 40 illustrated in FIG. 2 and includes a top wall 41′, a bottom wall 42, a front wall 43′, a back wall 44′, a right sidewall 46 and a left sidewall 47. The optional lid is not illustrated in FIG. 6. The container 100 also includes a divider 56, which is not shown but is similar to or the same as the divider 56 described above, a first dispensing outlet 102 and a second dispensing outlet 104. The first dispensing outlet 102 is formed on the back wall 44 and a portion of the top wall 41′, and the second dispensing outlet 104 is formed on the front wall 43′ and a portion of the top wall 41′. The dispensing outlets 102, 104 are formed in the respective walls by perforating a portion 81, 81′ of the walls in a desired shape, for example. As will be appreciated, the shape of the perforated portions 81, 81′ in this embodiment provides an apex 81a, 81a′ to facilitate piercing or tearing the perforations and an overall shape to open access to the container interior in an exemplary shape opening. Other shapes may be used, too.

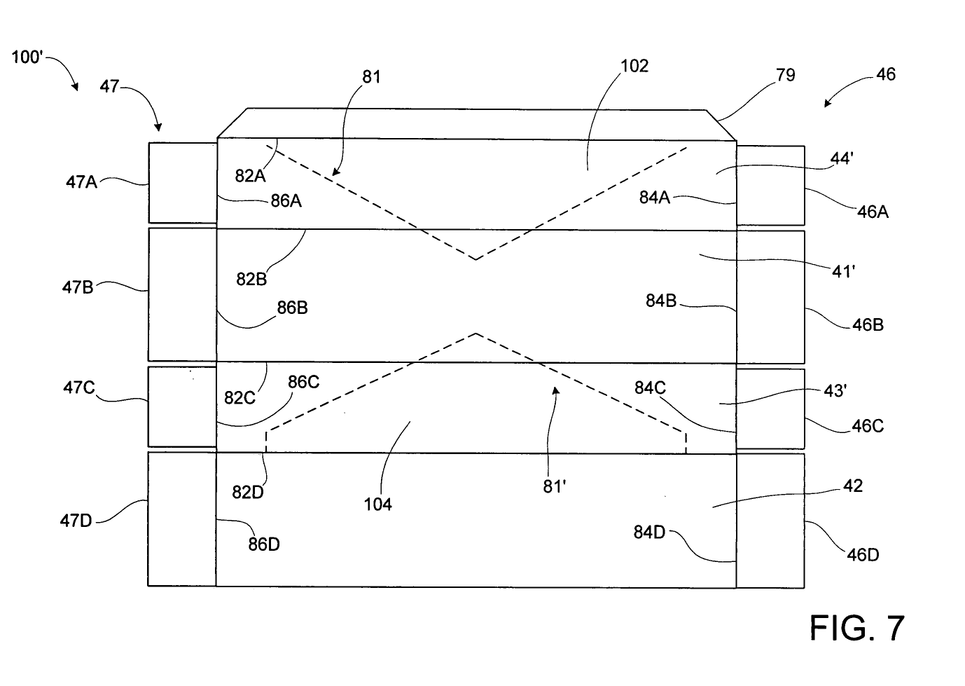

Moving to FIG. 7, a plan view 100′ of the container 100 is illustrated. As can be seen in FIG. 7, the plan view 100′ includes the top wall 41′, the bottom wall 42, the front wall 43′, the back wall 44′ and a flap 79. As was described above, form guides 82A-82D indicate where to fold or “form” the material to create the rectangular container shape. The sidewalls 46, 47 of the container 100 are formed from several sidewall flaps. For example, the right sidewall 46 includes four right flaps 46A-46D and the left sidewall 47 includes four left flaps 47A-47D. Right sidewall form guides 84A-84D indicate where the right sidewall flaps 46A-46D are folded and/or formed to create the right sidewall 46 of the container 100, and left sidewall form guides 86A-86D indicate where the left sidewall flaps 47A-47D are folded and/or formed to create the left sidewall 47 of the container 100.

The first dispensing outlet 102 is formed on the back wall 44′ and a portion of the top wall 41′, and the second dispensing outlet 104 is formed on the front wall 43′ and a portion of the top wall 41′ by perforating a portion 81,81′ of the respective walls in a desired pattern, for example.

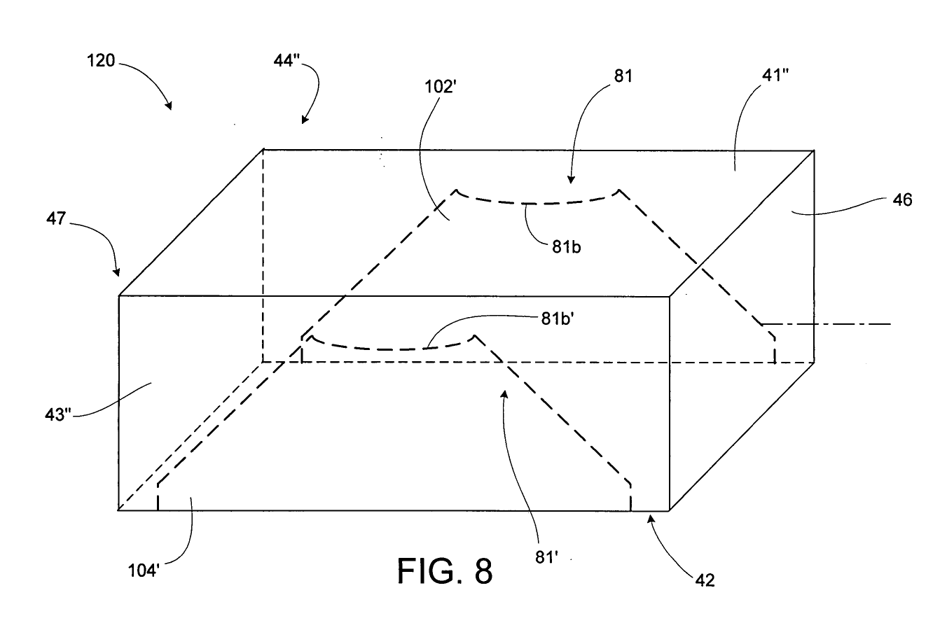

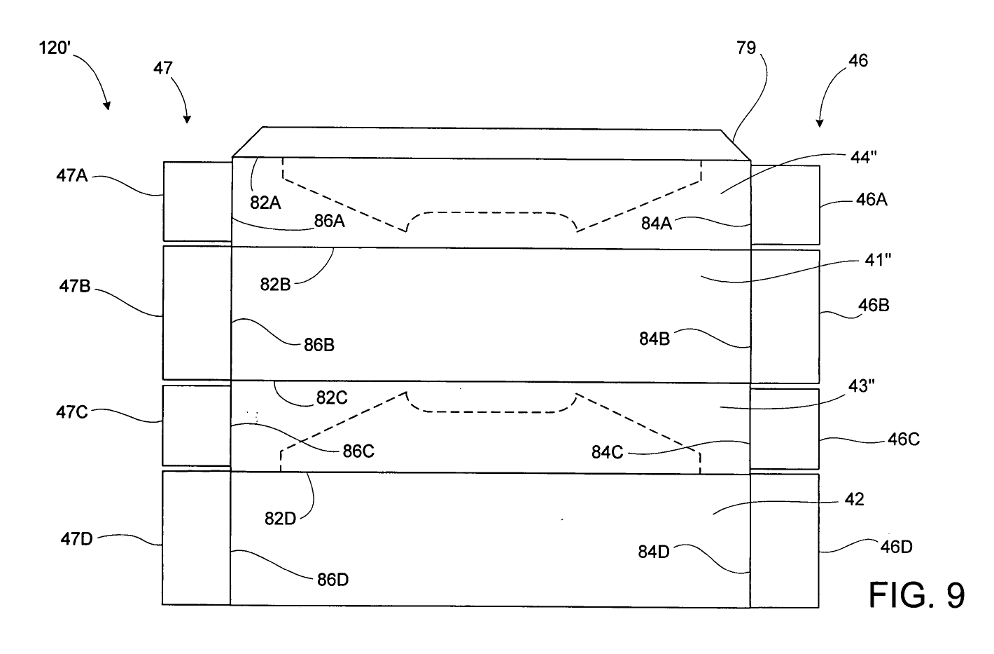

Referring now to FIG. 8, another embodiment of container 120 is illustrated. The container 120 is similar to the container 100 illustrated in FIG. 6 and includes a top wall 41″, a bottom wall 42, a front wall 43″, a back wall 44″, a right sidewall 46 and a left sidewall 47. The container 120 also includes a divider 56, which is not shown but is similar to or the same as the divider 56 described above, a first dispensing outlet 102′ and a second dispensing outlet 104′. The first dispensing outlet 102′ is formed on the back wall 44″ and the second dispensing outlet 104′ is formed on the front wall 43″. The dispensing outlets 102′, 104′ are formed in the respective walls by perforating a portion 81, 81′ of the walls in a desired shape, for example. The peaks or apices 81b, 81b′ of the perforations are concave curved to facilitate controlled tearing of the perforations and forming a desired shape opening to provide access to the interior of the container.

Moving to FIG. 9, a plan view 120′ of the container 120 is illustrated. As can be seen in FIG. 9, the plan view 120′ includes the top wall 41″, the bottom wall 42, the front wall 43″, the back wall 44″ and a flap 79. As was described above, form guides 82A-82D indicate where to fold or “form” the material to create the rectangular container shape. The sidewalls 46, 47 of the container 120 are formed from several sidewall flaps. For example, the right sidewall 46 includes four right flaps 46A-46D and the left sidewall 47 includes four left flaps 47A-47D. Right sidewall form guides 84A-84D indicate where the right sidewall flaps 46A-46D are folded and/or formed to create the right sidewall 46 of the container 120, and left sidewall form guides 86A-86D indicate where the left sidewall flaps 47A-47D are folded and/or formed to create the left sidewall 47 of the container 120.

The containers 100,120 may be used in a similar way as the container 40 may be used. The divider 56 separates portions of the containers 100, 120 into two compartments like the compartments 58, 60 described above. Bags may be withdrawn from the respective dispensing outlets 102, 104,102′, 104′ which are in the back wall 44′ and front wall 43′ (container 100) or on the back wall 44″, front wall 43″ and the top wall 41″ (container 120).

It will be appreciated that the invention may be used to store plastic bags of different sizes (or of the same size) and to dispense those bags from respective compartments in the container or package in which the bags are stored. For the purpose of storing bags of different sizes the container may use less space than two separate containers may require. The container may be used to store and to dispense materials other than plastic bags, as was described above. Furthermore, it will be appreciated that although the container embodiments illustrated in the drawings have two compartments, the features of the invention may be used in embodiments in which there are more than two compartments, e.g., the compartments being formed by cooperation with a divider of appropriate shape and the walls of the container, and an appropriate number of dispensing outlets may be provided at appropriate places in the container walls for dispensing the bags, etc., from the respective compartments.

While particular embodiments of the invention have been described in detail, it is understood that the invention is not limited correspondingly in scope, but includes all changes, modifications and equivalents coming within the spirit and terms of the claims appended hereto. For example, the container may be constructed to dispense three or more types of bags. Additional dispensing outlets can be formed in the container to accommodate each bag type, and the divider can be constructed with additional vertical walls to create the required number of compartments within the container for each bag type. Additionally, the divider and container may be constructed as an integral unit, as opposed to two separate units.

It will be appreciated that features of one embodiment disclosed herein may be used in the same way or similar way in another embodiment.

1. A packaging device, comprising:
a container;
a divider cooperative with at least a portion of the container forming a plurality of compartments within the container; and
a plurality of dispensing outlets in the container to dispense respective objects from the respective compartments.

2. The device of claim 1, wherein the dispensing outlets are perforated outlets in at least one wall of the container.

3. The device of claim 1, wherein the dispensing outlets are on a common wall of the container.

4. The device of claim 1, wherein the dispensing outlets are on multiple walls of the container.

5. The device of claim 1, wherein the divider comprises at least one substantially vertical wall attached to a base.

6. The device of claim 5, wherein the at least on vertical wall and the base are formed as an integral unit.

7. The device of claim 5, wherein a center portion of the base is raised above a side portion of the base.

8. The device of claim 5, wherein the base comprises a substantially planar member.

9. The device of claim 1, wherein the divider is permanently attached to at least one container wall.

10. The device of claim 1, wherein the divider floats within a plurality of container walls.

11. The device of claim 1, further comprising a plurality of bags, wherein the bags are stored in each of the compartments.

12. The device of claim 11, wherein the bags in at least one of the compartments are different from the bags in the remaining compartments.

13. The device of claim 1, wherein the divider isolates each of the plurality of compartments from other compartments.

14. The device of claim 1, wherein the container is formed from a material in the group consisting of paper, cardboard, plastic and metal.

15. The device of claim 1, further comprising a lid, said lid being cooperatively attached to the container.

16. The device of claim 15, wherein the lid extends over the dispensing outlets.

17. A method of packaging sheet-like objects, comprising the steps of:
providing a container to house the objects;
creating a plurality of dispensing outlets;
placing a divider in the container, wherein the divider forms a plurality of compartments within the container, and each of the plurality of compartments corresponds to one of the plurality of dispensing outlets;
placing a plurality of sheet-like objects in each of the plurality of compartments; and
closing the container.

18. The method of claim 17, wherein the step of forming a plurality of dispenser outlets includes perforating at least one surface of the container to form each outlet.

19. The method of claim 17, wherein the step of creating a plurality of dispensing outlets includes creating the dispensing outlets on a common wall of the container.

20. The method of claim 17, wherein the step of creating a plurality of dispensing outlets includes creating the dispensing outlets on multiple walls of the container.

21. The method of claim 17, wherein the step of placing a divider in the container includes forming at least one substantially vertical wall and attaching the at least one substantially vertical wall to a base.

22. The method of claim 17, wherein the step of placing a divider in the container includes forming at least one substantially vertical wall.

23. The method of claim 17, wherein the step of placing a divider in the container includes attaching the divider to at least one wall of the container.

24. The method of claim 23, wherein the step of attaching the divider to at least one wall of the container includes bonding the divider to the at least one container wall.

25. The method of claim 17, wherein the step of placing a divider in the container includes placing the divider in the container so the divider floats within a plurality of container walls.

26. The method of claim 17, wherein the step of placing a divider in the container includes forming a divider that includes at least one substantially vertical wall and a base constructed as an integral unit.

27. The method of claim 17, further comprising the steps of storing a plurality of bags in each of the compartments.

28. The method of claim 27, wherein the step of storing a plurality of bags includes using a plurality of bag types.

29. A method of dispensing from a container sheet-like material having different characteristics, wherein material having one characteristic is in one compartment of the container and material having a different characteristic is in a different compartment of the container, comprising,
withdrawing material having one of such characteristics from the respective compartment of the container via a respective dispensing outlet associated with such compartment.

30. The method of claim 29, further comprising the step of:
opening a lid to expose the dispensing outlets.

31. The method of claim 30, further comprising the step of:
closing the lid to cover the dispensing outlets.
